(19) United States
(12) Patent Application Publication
(10) Pub. No.: US 2018/0233310 A1
(43) Pub. Date: Aug. 16, 2018

(54) THERMOSENSITIVE ACTUATING UNIT

(71) Applicant: Littelfuse Japan G.K., Tokyo (JP)

(72) Inventor: Arata Tanaka, Minato-ku (JP)

(73) Assignee: Littelfuse Japan G.K., Tokyo (JP)

(21) Appl. No.: 15/896,558

(22) Filed: Feb. 14, 2018

(30) Foreign Application Priority Data
Feb. 14, 2017 (JP) 2017-025079

(51) Int. Cl. H01H 37/52; H02H 5/04; B32B 15/01; C22C 22/00; C22C 19/00; C25D 5/12; C25D 5/34

(52) U.S. Cl. CPC H01H 37/52; H02H 5/04; B32B 15/01; C25D 5/34; C22C 19/005; C25D 5/12; C22C 22/00

(57) ABSTRACT

A thermosensitive actuating unit which uses an alloy containing maganese and of which the contained maganese is less likely to be corroded. Provided is a thermosensitive actuating unit which is constituted to have a thermosensitive actuating element which has a manganese surface and a plating layer which covers the manganese surface.

This application claims priority to and the full benefit of Japanese Patent Application No. 2017-025079, filed on Feb. 14, 2018, and titled “THERMAL ACTIVATING COMPONENT,” the entire contents of which application is incorporated herein by reference.

### BACKGROUND

### 1. Technical Field

The present invention relates to a thermosensitive actuating unit.

### 2. Related Art

A clad material such as a bimetallic unit has been known as a thermosensitive actuating unit. The bimetallic unit is constituted to have a sheet material of bimetallic metal. When the temperature of the bimetallic unit exceeds a specific temperature and becomes high or the temperature of the bimetallic unit exceeds a specific temperature due to the high ambient atmosphere temperature and becomes high, the bimetallic unit is deformed. The bimetallic unit, for example, is incorporated in an electric device or the like and can function as a protection unit.

Specifically, the protection device disclosed in Japanese Unexamined Patent Publication No. 2005-203277 can be exemplified as a protection device in which such a bimetallic unit is incorporated. In the protection device, a resin base and a resin cover are integrally adhered to each other by adhesive or ultrasonic melting in a state where a PTC unit, a bimetallic unit, and an arm are disposed in a space provided in the resin base having a terminal and the resin cover in which an upper plate is provided in advance is disposed on the resin base. The bimetallic unit is operated when the electrical device becomes abnormally hot due to overcurrent or other reason and blocks current by opening a contact point.

### SUMMARY OF INVENTION

### 1. Problem to Be Solved by Invention

In the protection device of the related art described above, a bimetallic unit is operated when the temperature of the device exceeds a specific temperature due to overcurrent or other reason and current is blocked by opening the contact points of a terminal and an arm. In this case, it is preferable that the distance between the opened contact point of the terminal and the contact point of the arm be set to be as large as possible for reliably blocking the current. However, according to miniaturization of electronic equipment in recent years, the size of the bimetallic unit used is also reduced, and thus it is difficult to provide a large gap between contact points during operation.

It has been found that a bimetallic unit using an alloy containing maganese having a high thermal expansion coefficient is used for a high expansion layer to provide a gap between contact points during operation, and the curvature coefficient of the bimetallic unit is increased. However, as a result of further study, it is has been found that maganese is prone to corrosion and the thickness of a bimetallic unit is increased when the maganese in the bimetallic unit is corroded, and thus there is a problem in that the increase in the thickness results in lifting the arm of the bimetallic unit and the contact points are open.

An object of the present invention is to provide a thermosensitive actuating unit which uses an alloy containing maganese wherein the maganese is less likely to be corroded.

### 2. Means for Solving the Problem

In accordance with the present disclosure, the maganese in the thermosensitive actuating unit can be prevented by covering the entirety of the thermosensitive actuating unit (generally, a bimetallic unit) with a protective plating.

According to a first aspect of the present invention, there is a provided a thermosensitive actuating unit which includes a thermosensitive actuating element which has a maganese surface and a plating layer which covers the maganese surface.

According to a second aspect of the present invention, there is provided a protection device which is includes the thermosensitive actuating unit described above.

### Effect of the Invention

According to the present invention, the corrosion of maganese in a thermosensitive actuating element can be prevented by covering a maganese surface of the thermosensitive actuating element with a plating layer.

### BRIEF DESCRIPTION OF THE DRAWINGS

FIGS. 1A to 1C are views illustrating the laminated state of a clad material.

FIGS. 2A to 2C are views illustrating the laminated state of a clad material.

FIG. 3 illustrates a schematic perspective view of a protection device 11 of the present disclosure.

FIG. 4 illustrates a schematic cross-sectional view taken along a plane perpendicular to the plane including the line x1-x2 of the protection device 11 of FIG. 3.

### MODE FOR CARRYING OUT THE INVENTION

The thermosensitive actuating unit of the present invention may include a thermosensitive actuating element having a maganese surface and a plating layer covering the maganese surface.

The thermosensitive actuating element means an element which operates by sensing the temperature, in other words, an element of which the shape is deformed in accordance with the temperature.

The maganese surface means a surface with exposed manganese atoms. The maganese surface includes not only the surface with exposed maganese atoms which is provided in a main surface of the thermosensitive actuating unit but also a portion with exposed maganese atoms which is provided in a side surface (in a case of the bimetallic element, for example, a cross-section surface obtained after the clad material as a raw material is subjected to punching) of the thermosensitive actuating unit.

In the thermosensitive actuating element having the maganese surface, the maganese surface may be provided over the entirety of the element or may be provided in a part of the element.

An element (a so-called clad material) in which a plurality of layers having different thermal expansion coefficients are bonded to each other, a shape memory alloy, and the like can be exemplified as the thermosensitive actuating element.

In a preferred embodiment, the thermosensitive actuating element is a clad material in which a plurality of layers having different expansion coefficients are bonded to each other. In a particularly preferred embodiment, the thermosensitive actuating element is a two-layered clad material which is a so-called a bimetallic element.

In the clad material described above, the number of layers is not particularly limited. The number of layers may be two or more, preferably, two to five, further preferably, two or three. Generally, the clad material is a bimetallic element.

In the clad material described above, materials forming respective layers may be the same or different. However, at least two layers are constituted from materials having different thermal expansion coefficients.

At least one layer of the layers described above is formed of an alloy containing maganese. Preferably, the alloy containing maganese may be, for example, a Ni—Mn—Fe alloy, a Mn—Ni—Cu alloy, or the like.

The amount of manganese in the alloy is not particularly limited. However, the amount of manganese by weight in the alloy may be in a range of between, for example, 0.1 weight % and 90 weightweight %, preferably 1.0 weightweight % and 70 weightweight %, further preferably 5 and 60 weightweight %, and further preferably 20 and 50 weightweight %.

Iron, nickel, copper, silver, gold, aluminum, zinc, chromium, cobalt, molybdenum, titanium, tin and the like, and an alloy thereof, for example, Ni—Fe alloy, Cr—Fe alloy, Ni—Cr—Fe alloy, Ni—Co—Fe alloy, Ni—Cr alloy, Ni—Cu alloy, Ni—Mo—Fe alloy, Cu—Zn alloy, Ag—Cu alloy, Ag—Sn alloy, An-Cu alloy and the like, are exemplified as materials forming each of other layers.

In the preferred embodiment, the material forming other layer may be copper, nickel, Ni—Fe alloy, Cu—Zn alloy, Ni—Cu alloy, or Ni—Cr—Fe alloy.

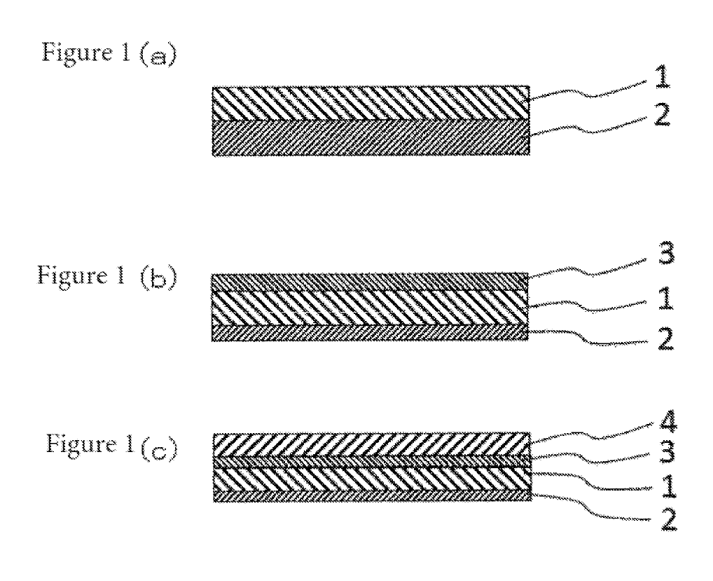

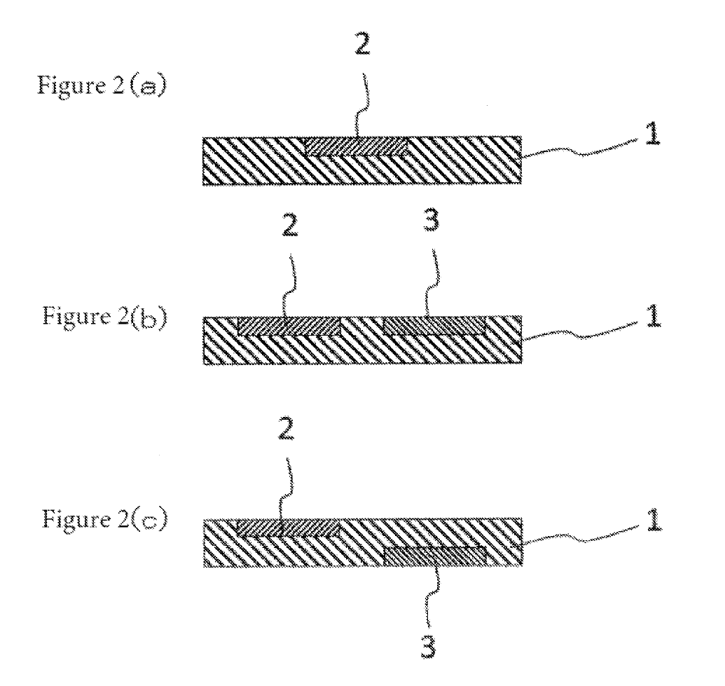

The shape of each layer in the clad material is not particularly limited. In an embodiment, the clad material may have a shape in which respective layers are bonded to each other over the entirety of the surface. In this case, the number of layers may be two or more, for example, two, three or four (see FIGS. 1A, 1B, and 1C). In another embodiment, the clad material may have a shape in which one layer is bonded to a part of the surface of the other layer. In this case, the number of the other layers may be one (see FIG. 2A, for example) or the number of the other layers may be two on one main surface (see FIG. 2B, for example). In addition, the number of other layers may be two in total, one on a separate main surface (see FIG. 2C). In the drawings, reference numerals 1 to 4 respectively indicate layers constituting the clad material.

The thickness of each layer is not particularly limited. The thickness of each layer may be set in the range between, for example, 0.01 mm and 1.0 mm, preferably 20 and 100 μm, further preferably 20 and 50 μm, and further preferably 25 and 35 μm.

The thickness of the entirety of the clad material is not particularly limited and it may be set in the range between, for example, 0.02 mm and 2.0 mm, preferably 20 and 200 μm, further preferably 40 and 80 μm, and further preferably 50 and 70 μm.

The shape of the thermosensitive actuating element is not particularly limited. The planar shape of the thermosensitive actuating element may be a polygon, for example, a rectangle, a trapezoid, a triangle, a circle, an ellipse, or a combination thereof and the cross-sectional shape may be a polygon, for example, a quadrangle, a circle, an ellipse, or a combination thereof.

In an embodiment, the thermosensitive actuating element has a planar shape of rectangular or circular and the size of one side or the diameter may be preferably equal to or less than 50 mm, and further preferably equal to or less than 30 mm may be set in the range between, for example, 5 mm and 30 mm or 10 mm and 30 mm.

In the preferred embodiment, the thermosensitive actuating element described above is a bimetallic element in which a Ni—Fe alloy layer is provided as a layer having a low thermal expansion coefficient and a Ni—Mn—Fe alloy or Mn—Ni—Cu alloy layer is provided as a layer having a high thermal expansion coefficient.

The plating layer described above is formed on the manganese surface of the thermosensitive actuating element described above. The plating layer described above may cover the manganese surface of the thermosensitive actuating element and the non-manganese surface may not be covered with the plating layer.

In an embodiment, the entirety of the thermosensitive actuating element is covered with a plating layer. The entirety of the element is covered with the plating layer, and thus it is easy to perform a plating treatment.

The material forming the plating layer described above is not particularly limited and, for example, nickel, tin, gold, silver, copper, palladium or an alloy thereof can be used as the material. The material is preferably nickel, gold, palladium or an alloy thereof, further preferably nickel, gold, or palladium, and further preferably nickel.

The plating layer described above may be constituted of a single layer or multiple layers, for example, two or three layers. Preferably, the plating layer described above is constituted of multiple layers, preferably, two or three layers.

In order to preserve the function of the thermosensitive actuating element, it is preferable that the thickness (in the case of multiple layers, the total thickness) of the plating layer be as small as possible. However, in order to effectively protect the manganese from corrosive substances, it is preferable that the thickness is adequately large. The thickness (in the case of multiple layers, the total thickness) of the plating layer described above is preferably set in the range between 0.001 μm and 10 μm, further preferably 0.01 μm and 1.0 μm, further preferably 0.05 μm and 0.8 μm.

The difference in the thickness of the plating layer in the same plane may be preferably equal to or less than 0.1 μm, further preferably equal to or less than 0.05 μm. The thickness of the plating layer is set to be uniform, and thus it is possible to suppress variations in the properties of the thermosensitive actuating unit.

In an embodiment, a strike plating layer is provided on the manganese surface of the thermosensitive actuating element and a main plating layer is provided thereon. Strike-plating is performed as described above, and thus it is possible to perform main-plating further favorably.

In the preferred embodiment, the strike plating layer described above is a nickel strike plating layer and the main plating layer described above is a nickel plating layer. Adhesiveness and uniformity of the plating layer are further improved by adopting such a configuration.

In the preferred embodiment, in the thermosensitive actuating unit of the present invention, a layer formed of a Ni—Fe alloy, a bimetallic element constituted of a layer formed of a Ni—Mn—Fe alloy or a Mn—Ni—Cu alloy, and at least the surface of the Ni—Mn—Fe alloy or the Mn—Ni—Cu alloy are covered with a nickel plating layer. The nickel plating layer is constituted of a nickel strike plating layer and a nickel main plating layer.

The thermosensitive actuating unit of the present invention can be manufactured by subjecting the thermosensitive actuating element to a plating treatment. Hereinafter, the plating treatment on the manganese surface of the thermosensitive actuating element may be described.

Conventionally, The plating adhesion of manganese is low, and thus it is difficult to perform a plating treatment on the manganese surface. Especially in the field of electronic components, when the plating treatment is performed on the manganese surface, plating adhesion is low and manganese causes a reaction such as oxidation, and thus there is a problem in that the electrical properties and operating properties of the thermosensitive actuating unit tend to vary. As a result of earnest study, the inventor of the present invention conceived that an appropriate strike plating treatment is performed prior to a main plating treatment, in such a manner that the variation in electrical properties and operating properties of the obtained thermosensitive actuating unit is suppressed and a plating layer having high adhesion can be obtained. Hereinafter, the plating process used in the present invention will be described.

The strike plating treatment described above is perfumed in a state where the temperature of the plating bath is maintained in a predetermined temperature range between, for example, 10° C. and 25° C., preferably 15° C. and 25° C. The temperature of the plating bath is maintained in the predetermined temperature range as described above, and thus blackening and poor adhesion due to oxidation of manganese can be mitigated.

The pH of the plating bath for strike plating is set in the range between, preferably, 1.0 and 2.0, further preferably 1.3 and 1.6. In addition, the current density is set to the range between, preferably, 1 and 10 A/dm2, and further preferably, 2 and 5 A/dm2.

The strike plating layer is preferably a nickel strike plating layer. The nickel strike treatment can be performed with, preferably, a sulfamic acid bath.

The main plating treatment is performed in a state where the temperature of the plating bath is maintained in a predetermined temperature range, for example, equal to or less than room temperature, for example, between 30° C. and 80° C., preferably, 40° C. and 60° C. As described above, the temperature of the plating bath is maintained in the predetermined temperature range, and thus it is possible to mitigate blackening and poor adhesion of the manganese due to oxidation.

The pH of the plating bath for main plating is set in the range between, preferably, 2.0 and 5.0, further preferably 3.0 and 4.5, further preferably 4.0 and 4.5. In addition, the current density is set in the range between, preferably, 0.5 and 8 A/dm2, further preferably, 2 and 5 A/dm2.

The main plating treatment described above may be performed once or multiple times. However, it is preferable that the treatment be performed multiple times. In other words, it is preferable that the main plating layer be formed in multiple plating steps. As described above, the main plating layer is gradually formed by repeating the main plating treatment multiple times, and thus it is possible to form the main plating layer further uniformly.

In the preferred embodiment, a plating process may include one or more pretreatments described below.

Pretreatment

(a) Degreasing Treatment

The thermosensitive actuating element is subjected to a degreasing treatment. The degreasing treatment can be performed as similar to the regular plating process and alkali immersion, emulsion washing, electrolytic degreasing or the like can be used.

(b) Acid Cleaning

The thermosensitive actuating element is cleaned with acid.

The acid to be used is not particularly limited and, preferably hydrochloric acid, sulfuric acid, and mixtures thereof are exemplified. Preferably, a mixture of hydrochloric acid and sulfuric acid is used.

It is preferable that all of the pretreatment described above be performed.

The thermosensitive actuating unit of the present invention has a high curvature coefficient and a high environmental resistance. Therefore, the unit can be suitably used in a protection device of an electronic component. The present invention also provides a protection device which is constituted to have the thermosensitive actuating unit of the present invention.

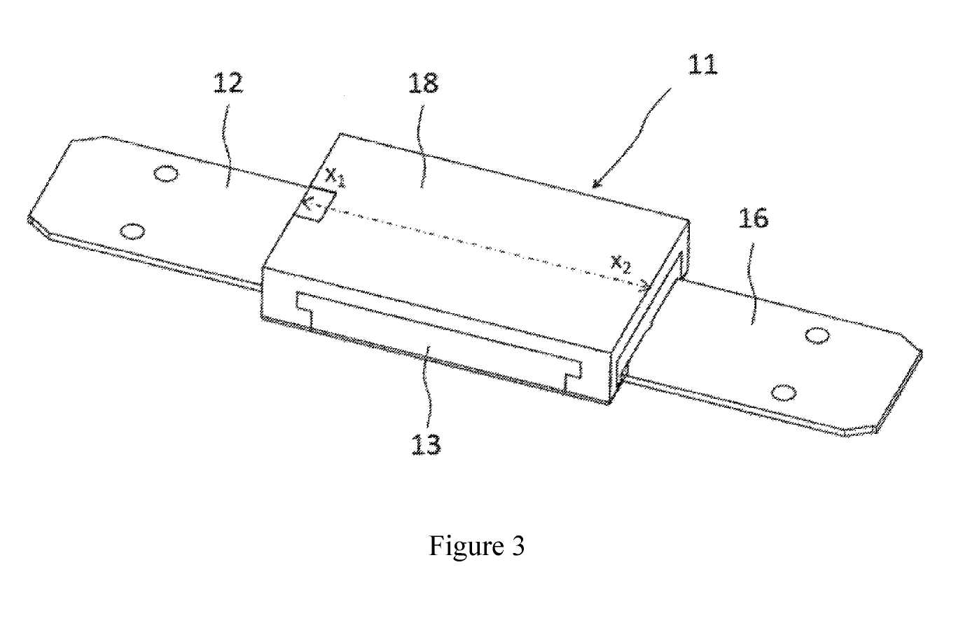

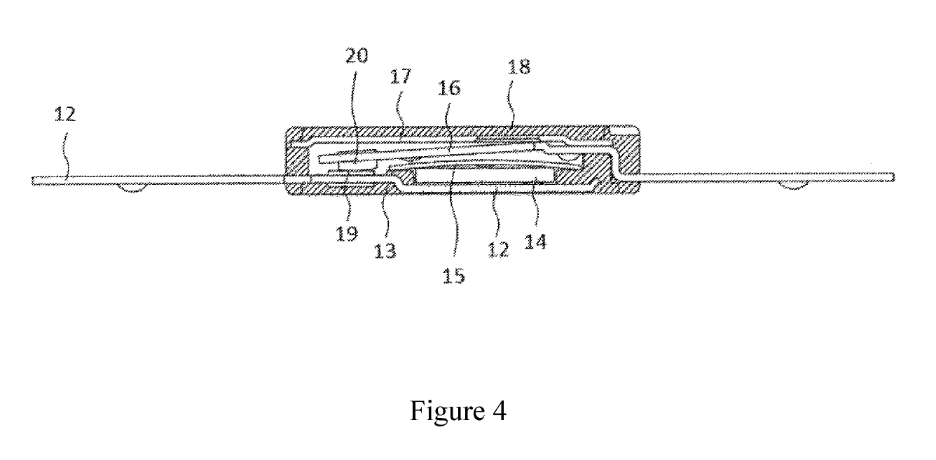

In the embodiment, as illustrated in FIGS. 3 and 4, a protection device 11 of the present invention is constituted to have a resin base 13 having a terminal 12, a PTC unit 14, the thermosensitive actuating unit 15 of the present invention, the arm 16, the upper plate 17 and the resin cover 18, in which the PTC unit 14, the thermosensitive actuating unit 15, the arm 16, and the upper plate 17 are laminated on the terminal 12 in a space in the resin base 13 in order and the resin cover 18 is located to cover these, in which normally the terminal 12 and the arm 16 are electrically connected in series, and in which, when the bimetallic unit operates abnormally, the contact point 19 of the terminal 12 and the contact point 20 of the arm 16 are electrically disconnected and the terminal 12, the PTC unit 14, the thermosensitive actuating unit 15, and the arm 16 are electrically connected in series in order.

In the preferred embodiment, the thermosensitive actuating unit 15 is a bimetallic unit.

The protection device 11 of the present invention uses the thermosensitive actuating unit 15 of the present invention, and thus the protection device 11 can be greatly curved and the distance between the contact point 20 of the arm 16 and the contact point 19 of the terminal 12 can be greatly increased. Therefore, the protection device 11 of the present invention is advantageous for miniaturization.

In the preferred embodiment, in the protection device 11 of the present invention, the size of the main body portion constituted of the resin base 13 and the resin cover 18 may be 5.0 mm or less in length, 3.0 mm or less in width, and 0.9 mm or less in height, preferably 4.6 or less in length, 2.8 or less in width, and 0.85 or less in height.

Hereinbefore, the present invention is described with reference to the drawings. However, the present invention is not limited thereto and various modifications are possible.

### EXAMPLE

### Example 1: Manufacture Thermosensitive Actuating Unit of the Present Invention

The bimetallic element described below is prepared as the thermosensitive actuating element.
BR-1 (manufactured by Neomax Engineering Co., Ltd)

High thermal expansion coefficient side: Mn alloy (thickness: about 30 μm)

Low thermal expansion coefficient side: Non-Mn alloy (thickness: about 30 μm)

The bimetallic element described above is punched to 2.9 mm in length and 2.9 mm in width to obtain a bimetallic piece. The obtained bimetallic piece is subjected to degreasing.

Next, the bimetallic piece is cleaned with a mixed solution of hydrochloric acid and sulfuric acid (temperature: 20° C.) and the rust of the surface of the bimetallic piece is cleaned.

Next, the nickel strike plating treatment is performed under the condition described below.

Wood bath for nickel strike

Main ingredient: nickel chloride 240 g/l

Additive: hydrochloric acid 125 g/l

Bath temperature: 20 to 25° C.

Current density: 2˜5 A/dm2

Next, the main plating treatment is performed under the condition described below.

Sulfamic acid bath for nickel strike

Main ingredient: nickel chloride 30 g/l
sulfamic acid 400 g/l
nickel bromide 40 g/l
boric acid 30 g/l

Bath temperature: 40 to 60° C.

Current density: 2˜5 A/dm2

By the processing described above, the thermosensitive actuating unit of the present invention in which a nickel plating layer is provided over the entirety of the bimetallic piece is obtained.

### Test Example

Twelve thermosensitive actuating units of the present invention which is obtained as described above and twelve bimetallic pieces which is not subjected to a plating treatment are subjected to an environmental resistance test under the condition of the temperature of 60° C. and the humidity of 90%. The Mn surface and the non-Nm surface of the bimetallic piece are observed before the test (0 hour), after 500 hours and 100 hours. The results are shown in the following table.

TABLE 1

| | Blackening | | | |
|---|---|---|---|---|
| | Ni plating BR-1 | | BR-1 | |
| Elapsed time | | Non-Mn | | Non-Mn |
| (hour) | Mn surface | surface | Mn surface | surface |
| 0 | No | No | No | No |
| 500 | No | No | Yes | No |
| 1000 | No | No | Yes | No |

As shown in the above results, in the thermosensitive actuating unit of the present invention, blackening is not observed on the unit surface and the layer on the Mn surface (having a high thermal expansion coefficient) side of the bimetallic piece which is not subjected to a plating treatment is blackened. In other words, oxidation is observed. From the above results, it is confirmed that the thermosensitive actuating unit of the present invention is excellent in environmental resistance.

### INDUSTRIAL APPLICABILITY

The thermosensitive actuating unit of the present invention can be suitably used in a protection device of various electronic devices, particularly in a small protection device.

### DESCRIPTION OF REFERENCE NUMERALS

1˜4: layers constituting clad material
11: protection device
12: terminal
13: resin base
14: PTC unit
15: thermosensitive actuating unit
16: arm
17: upper plate
18: resin cover
19: contact point of terminal
20: contact point of arm

1. A thermosensitive actuating unit comprising:
a thermosensitive actuating element which has a manganese surface; and
a plating layer which covers the manganese surface.

2. The thermosensitive actuating unit according to claim 1, wherein the thermosensitive actuating element includes two or more metal layers which have different thermal expansion coefficients.

3. The thermosensitive actuating unit according to claim 1, wherein the thermosensitive actuating element is a bimetallic element.

4. The thermosensitive actuating unit according to claim 2, wherein at least one of the metal layers is an alloy layer containing manganese.

5. The thermosensitive actuating unit according to claim 2, wherein the alloy layer containing manganese is a Ni—Mn—Fe alloy or a Mn—Ni—Cu alloy.

6. The thermosensitive actuating unit according to claim 1, wherein the plating layer is formed over an entirety of the surface of the thermosensitive actuating element.

7. The thermosensitive actuating unit according to claim 1, wherein the plating layer is a nickel plating layer.

8. The thermosensitive actuating unit according to claim 1, wherein a difference in a thickness of the plating layer in the same plane is equal to or less than 0.1 μm.

9. A protection device comprising:
a thermosensitive actuating unit comprising:
a thermosensitive actuating element which has a manganese surface; and
a plating layer which covers the manganese surface.
